(19) United States
(12) Patent Application Publication
(10) Pub. No.: US 2024/0033172 A1
(43) Pub. Date: Feb. 1, 2024

(54) INTERCHANGEABLE PERCUSSIVE MASSAGE GUN HEADS

(71) Applicant: John Andrew Wells, Phoenix, AZ (US)

(72) Inventor: John Andrew Wells, Phoenix, AZ (US)

(21) Appl. No.: 17/803,965

(22) Filed: Feb. 10, 2023

Related U.S. Application Data
(60) Provisional application No. 63/474,190, filed on Jul. 28, 2022.

(51) Int. Cl. A61H 23/00

(52) U.S. Cl. CPC A61H 23/006; A61H 2201/1685

(57) ABSTRACT

Interchangeable primary massage heads for therapeutic treatment of body regions are mounted on secondary massage heads partially fitting inside of the primary massage heads. The secondary heads are fixed at proximal ends of intermediate mounting shafts in turn having distal ends fitting in or over drive shafts of percussive massage guns. Either primary or secondary massage head may be shaped as a bullet, disc, ball, spade, scraper, paddle or flexible net. A different embodiment is an adapter converter shaft formed as a secondary massage head shaped as a truncated conical cone with a center top hole sized to receive an intermediate mounting shaft on which a primary massage head is inserted. The adapter shaft has a distal end adapted to slip over short stroke drive shafts of compact massage guns enabling primary massage heads usage with either bigger or compact massage guns.

This application claims priority to, and benefit of U.S. Provisional Application No. 63/474,190 filed on 2022 Jul. 28 and incorporates the contents of such by reference in its entirety.

### FIELD OF THE INVENTION

The present invention relates generally to assortments of interchangeable massage heads inserted in or over drive shafts of cordless portable hand held battery operated percussive massage guns. It is an object of this invention to provide a user with a wide assortment of types of massage heads to maximize the therapeutic massage effect on different body regions. This invention discloses an assortment of secondary massage heads sized to mount within complementarily sized cavities of primary massage heads. An intermediate mounting shaft has a proximal terminal end mounting the secondary massage head and a distal end fitting within or over a drive shaft of the percussive massage guns.

### BACKGROUND OF THE INVENTION

Percussive massage guns are massage devices used in percussive therapy treatment. The massage guns employ a reciprocating shaft in which or on are detachably mounted a massage head selected from a variety of massage heads each with a specialized messaging surface or contour designed to provide comfort and relief to a user. A host of neurological ailments ranging from fatigue, stiffness, pain, muscle soreness, muscle tenseness, muscle knots, etc, are treated with controlled concentrated rapid pulses per second to apply massaging pressure to a localized body area. The massaging enhances flow of blood carrying oxygen to the treatment areas aiding in the flushing out of toxins in muscles which over time relaxes tight muscles. This stimulates production of nerve relaxing and mood enhancing chemical compounds, such as enkephalins and endorphins in the brain. Treated body areas range from specific trigger points and include most muscle groups, such as those of the neck, spine, stomach, arms, legs, and feet. For example, studies have shown that percussive therapy can prevent DOMS (Delay Onset Muscle Soreness) of the neck to relieve pain and soreness a result of overstraining of neck muscles.

Studies of athletic and fitness exercises have found use of massage guns prior to a warm-up session reduces volume of muscle micro-tearing. For post-exercise recovery, after an exercise session, use of massage guns aids in releasing muscle tension, working our muscle knots and relieving soreness. Different areas of the body respond best to massage therapy using specifically designed massage heads generally marketed in basic groups ranging from four to a over a dozen.

Well known massage heads in the percussive massage gun art have a variety of shapes. Examples include small and larger massage balls applied to muscle groups, flat discs and soft air bellows used for warm-ups or cool downs to specific or whole body muscle groups, cone trigger point heads applied to pain points, bullet massage heads applied to multi-layer muscle groups such as thighs, buttocks or legs, spade or scraper heads applied to thin skinned body areas, such as spine cervical vertebrae, elbows and ankles.

Known prior art massage heads are mounted over an intermediate mounting shaft having a mounting end unattached to a further secondary massage head.

### BRIEF SUMMARY OF THE INVENTION

The invention, developed by JAWKU, L.L.C., a Delaware Company, is directed to combinations or assemblies of interchangeable massage heads wherein each assembly consists of a primary massage head, a secondary massage head, and an intermediate mounting shaft. Each primary massage head has a cavity with a flexible rim opening made of a memory elastomer material. The secondary massage head is attached to a proximal end of the intermediate mounting shaft. The massage head has a portion sized to fit through the flexible rim opening to secure the secondary massage head within the cavity. The intermediate mounting shaft has a distal end sized to fit within bores of drive shafts of percussive massage guns, such as the JAWKU Muscle Blaster Chrome weighing 1.78 lbs (11 mm stroke) and the JAWKU Muscle Blaster V-2, weighing 2.2 lbs (14 mm stroke). In other embodiments, the intermediate drive shaft has a different distal end sized to slip over a short stroke (8 mm) drive shaft of a compact percussive massage gun such as the JAWKU Muscle-Blaster Mini weighing a pound.

One goal of the invention is to provide maximum mobility and compactness with accompanying savings in weight while providing an additional massage head, the secondary massage head above referenced.

Another goal is to provide the user a wide variety of suitable massage heads to ease discomfort, soreness and pain of tired muscles as well as promote healing of muscle injuries with the massaging effect promoting movement of blood carrying oxygen and removal of body waste dioxins.

### BRIEF DESCRIPTION OF THE DRAWINGS

FIG. 1 is a top view of a prior art soft double bellows massage head with an upper smaller bellows mounted over a larger bellows.

FIG. 1A is a side view of a prior art soft double bellows massage head with a top bellows having a large marbled center dome surface mounted on a lower bellows with a prior art intermediate mounting shaft inserted.

FIG. 2 is a top view of the intermediate mounting shaft of FIG. 1A.

FIG. 2A is an enlarged detail side view of the intermediate mounting shaft of FIG. 1A mounted through the bottom of the lower bellows (shown in phantom).

FIG. 2B is a side view of an embodiment of this invention showing an improvement to the intermediate mounting shaft of FIG. 2A in the shape of a rounded surface massage head for mounting inside the soft double bellows massage heads of FIG. 1 or FIG. 1A.

FIG. 2C is an exploded side view of another embodiment of an assembly of a soft double bellows massage head 39 for fitting over a flattened disc massage head 42 having an open ended flexible skirt 45 with a tapered inner rim lip 45b for engaging a groove 56a of a short-stroke drive shaft 56 of the JAWKU Muscle Blaster Mini percussion gun.

FIG. 2D is a view from beneath of the disc massage head 42 of FIG. 2C.

FIG. 3 is a top view of an embodiment of a ball massage head having a spike or nib surface.

FIG. 3A is a sideways view of the spiked ball massage head of FIG. 3.

FIG. 3B is a bottom view of the spiked ball massage head of FIG. 3 showing a hollow interior with a net mounted in the interior.

FIG. 4 is a side view of a bullet massage head with a knurled surface sized to fit within the hollow interior of a ball shaped larger massage head such as shown in FIGS. 3, 3A-3B.

FIG. 4A is a side view of a bullet massage head with a smooth surface and sized to fit within the hollow interior of larger massage heads such as shown in FIGS. 3-3B.

FIG. 4B is a bottom view of an embodiment of a hollow ball massage head having a granular surface showing an interior net 25 similar to FIG. 36.

FIG. 5 is an embodiment of a front view of a full surface serrated scraper blade massage head mounted on an intermediate mounting shaft.

FIG. 5A is a side view of the FIG. 5 full surface serrated scraper blade massage head showing in phantom outline a hollow interior when removed from the intermediate mounting shaft.

FIG. 5B is a front view of the full surface serrated scraper blade removed from the intermediate mounting shaft showing the hollow interior of the blade.

FIG. 5C is a front view of a fragmented upper portion of the intermediate mounting shaft showing a small raking massage head sized to fit within the hollow interior of the blade of FIG. 5B.

FIG. 5D is a rear view of the fragmented upper portion of the intermediate mounting shaft of FIG. 5B.

FIG. 5E is an enlarged bottom view of the massage head of FIG. 5A.

FIG. 5F is a sectional view taken from FIG. 5E along sectional arrows AA shown through the midpoint of FIG. 5E.

FIG. 5G is another embodiment showing an exploded front view of a scraper wide rake massage head having semi-spherical cavities for mounting by snapping over semi-spherical attachment balls of a smaller massage head on an intermediate mounting shaft.

FIG. 5H is a front view of another embodiment similar to FIG. 5G showing an array of flexible multi-level bullets of a massage head adapted to mount over an intermediate mounting shaft of a JAWKU Muscle Blaster Mini.

FIG. 5I is a top view of FIG. 5H.

FIG. 5J is a bottom view of FIG. 5H showing four mounting cavities.

FIG. 5K is a front view of the intermediate mounting shaft for the FIG. 5H bullet massage head.

FIG. 5L is a bottom view of the FIG. 5K intermediate mounting shaft.

FIG. 6 is an enlarged detailed bottom view of the ball of FIG. 4B.

FIG. 6A is a side view of the hollow ball massage head of FIG. 6 showing interior details in phantom outline.

FIG. 7 is an embodiment of exploded front and side views of a dual claw toe massage head having cavities above semi-spherical massage heads sized to snap fit inside the cavities.

FIG. 7A is a front view of an embodiment of a fork massage head for mounting the FIG. 7 semi-spherical heads.

FIG. 7B is a front view of an embodiment of a wide Y angled fork massage head for mounting the FIG. 7 semi-spherical heads.

FIG. 8 is an embodiment of an exploded front view of a hollow scraper massage head similar to FIG. 5A removed from a smaller massage head attached to an intermediate mounting shaft.

FIG. 8A is a bottom view of the hollow scraper massage head shown in the FIG. 8 embodiment similar to FIG. 5E.

FIG. 8B is a sectional view taken along sectional arrows BB through the midpoint of the scraper massage head of the FIG. 8 embodiment showing details of open spaced gripper tabs.

FIG. 8C is a side view of the FIG. 8 embodiment assembled.

FIG. 9 is a side view of another embodiment of a combination ring and ball of a massage head mounted internally by a massage hammer head attached to an intermediate mounting shaft.

FIG. 9A is a top view of the FIG. 9 embodiment.

FIG. 9B is a side view of FIG. 9 with the ring removed showing a groove circumnavigating the periphery of the ball.

FIG. 10 is a top view of a further embodiment of a net massage head.

FIG. 10A is a front view of the embodiment of FIG. 10.

FIG. 10B is a front view of the embodiment of FIG. 10 seated on ends of bars of a Y shaped end of an intermediate mounting shaft.

FIG. 10C is a front view of the Y shaped massage head of the FIG. 10 intermediate mounting shaft.

FIG. 10D is a top view of an embodiment of a round net massage head adapted to fit over a massage head of an intermediate mounting shaft of a JAWKU Muscle Blaster Mini.

FIG. 10E is a cross section view CC of the FIG. 10D embodiment.

FIG. 10F is a front view of the intermediate mounting shaft showing the massage surface used to mount the massage head of the FIG. 10D embodiment.

FIG. 11 is a prior art fork massage head with attached shaft.

FIG. 12 is a side view of an embodiment intermediate mounting shaft adapter

FIG. 12A being a more detailed sectional view of FIG. 12.

FIG. 12B is a top view of the adapter of FIG. 12.

### DETAILED DESCRIPTION OF THE SPECIFICATION

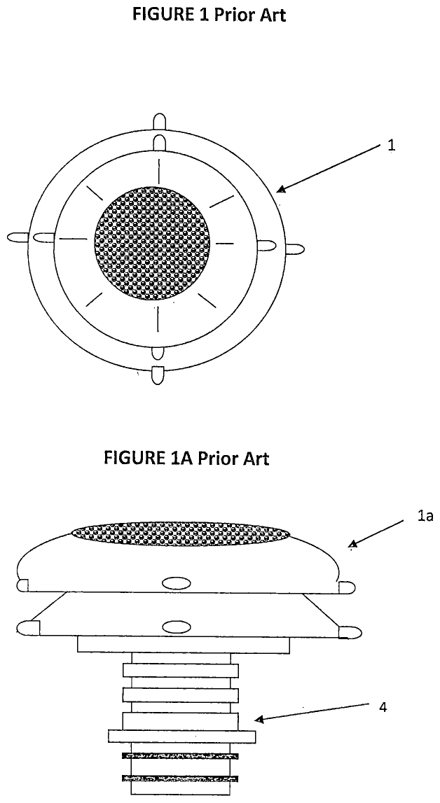

A top view of a prior art soft double bellows massage head 1 is shown in FIG. 1 with a side view of another prior art soft bellow massage head 1a fixed to a prior art intermediate mounting shaft 4 in FIG. 1A.

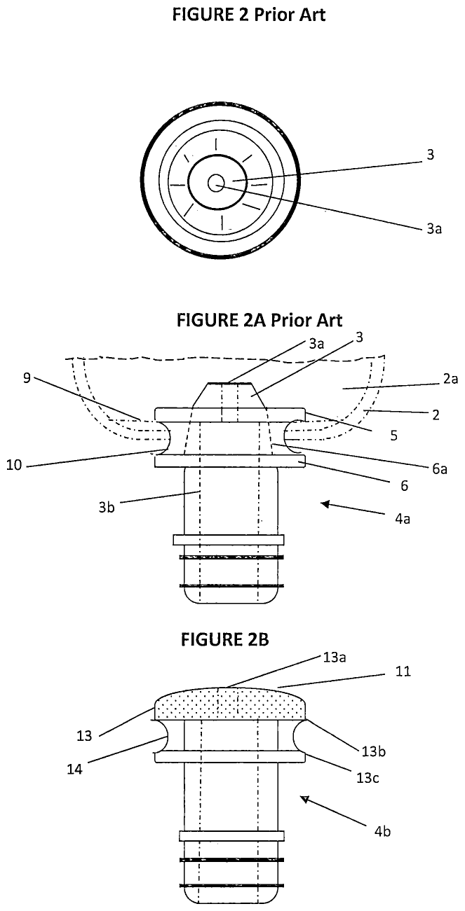

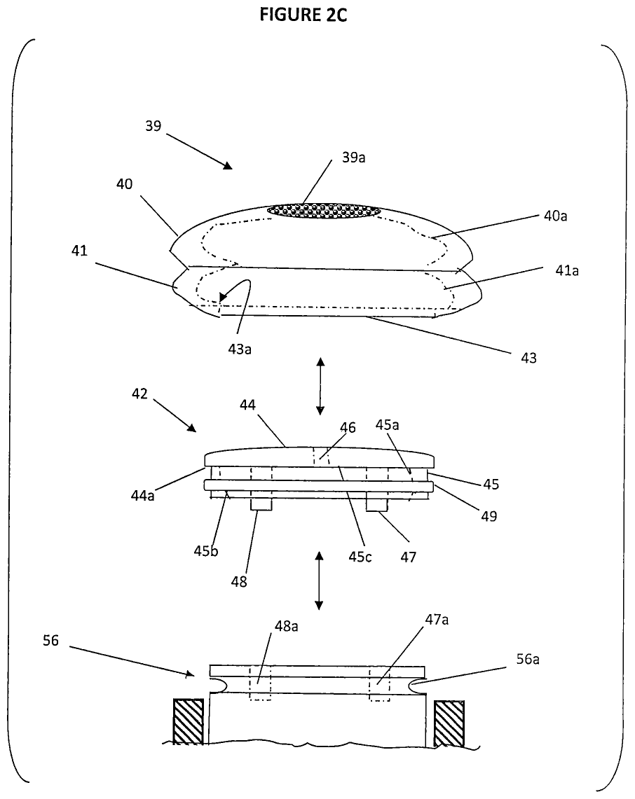

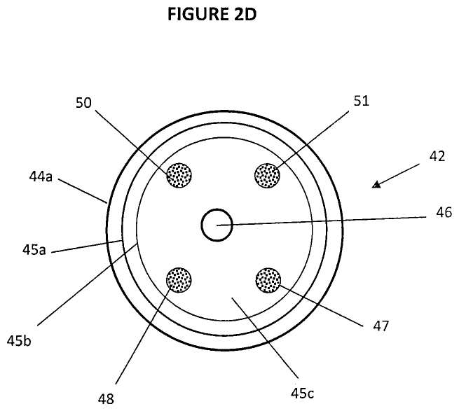

Referring to the enlarged view of FIG. 2A, a different prior art intermediate mounting shaft 4a has a groove 10 located between upper and lower rims 5, 6. A center truncated cone 3 extends above upper rim 5 to provide an air channel 3a when inserted into a bellows 2 having an air cavity 2a. The upper rim 5 has a space surrounding the cone 3. The truncated cone slopes down to merge with the lower rim 6 as shown by dotted lines 6a. Bellows 2 is a soft impact air bellows partially deformable upon impacting with a body area of a user upon massaging which softens the massage by letting air escape from the cavity 2a through air channel 3a. The upper rim 5 has a diameter larger than a diameter of a bottom opening rim 9 of the bellows 2. The bottom opening rim 9 is stretchable over the upper rim 5 and seals against groove 10. Shaft 4a with O-rings is inserted into a drive shaft of the massage gun.

The FIG. 2B embodiment of this invention simplifies the truncated cone 3 with a secondary duo purpose massage head 11 formed as a sphere cap to mount inside the cavity 2a. The sphere cap has a cylindrical base 13. Air is exhausted upon pressure on the bellows of the massage head through a center air channel 13a. The cylindrical base 13 has a diameter slightly longer than the diameter of the bottom opening rim 9 of FIG. 2A. Cylindrical base 13 has a slight overhang 13b over a groove 14 bounded by the overhang and a lower rim 13c. The sphere cap of massage head 11 presents a smooth surface suitable for massaging contact directly with either a wide area of skin or thin clothing of a user unlike the combination of the flat upper rim 5 disconnected from the raised truncated cone 3 of FIG. 2A.

A different embodiment developed for use with the JAWKU Muscle Blaster Mini massage gun is shown in FIG. 2C which is an exploded assembly view. This embodiment discloses a massage head assembly for mounting a soft massage head 39 having stacked bellows 40, 41. Upper bellows 40 has an air void formed by a curved inner surface 40a joined to an air void of bellows 41 by a curved inner surface 41a. Bellows 41 has a larger stretchable bottom opening rim 43 than the previously discussed bottom opening rim 9 of the prior art bellows 2 of FIG. 2A. The curved inner surface 41a terminates at a junction 43a of the bottom opening rim 43.

An intermediate mounting shaft 42 has a massage disc 44 with a diameter larger than the diameter of bottom opening rim 43. The massage disc has a bottom surface 44c with an overhang 44a with a downwardly extending flexible skirt 45. Overhang 44a is pressed against a junction 43a of the bellows opening rim 43 to secure the massage disc 44 inside the bellows 41. Flexible skirt 45 has an inner wall 45a with a inwardly directed lip 45b engaging a groove 56a circumnavigating a forward end of a massage gun shaft 56 having a short stroke (8 mm). The intermediate mounting shaft is slipped over the end of the massage gun drive shaft with the aid of a slightly protruding curb 49 attached to and circumnavigating the outer wall of the flexible skirt 45 providing a finger grip.

Plural centering poles 47, 48 optionally extend from the bottom surface 45c of the massage disc 44. These centering poles engage centering apertures 47a, 48a located in the drive shaft 56 shown at the bottom of FIG. 2C. Massage head 39 is a soft air bellows partially deformable upon contact with a body of a user. An open center channel 46 in the center of the massage disc 44 allows air escape.

The disc 44 serves duo purposes of being an intermediate connector for a larger primary soft bellows massage head as well as a secondary massage head when used alone. FIG. 2D is a bottom view of the circumference of the massage disc 44 having a larger diameter mounted above the smaller diameter flexible skirt 45.

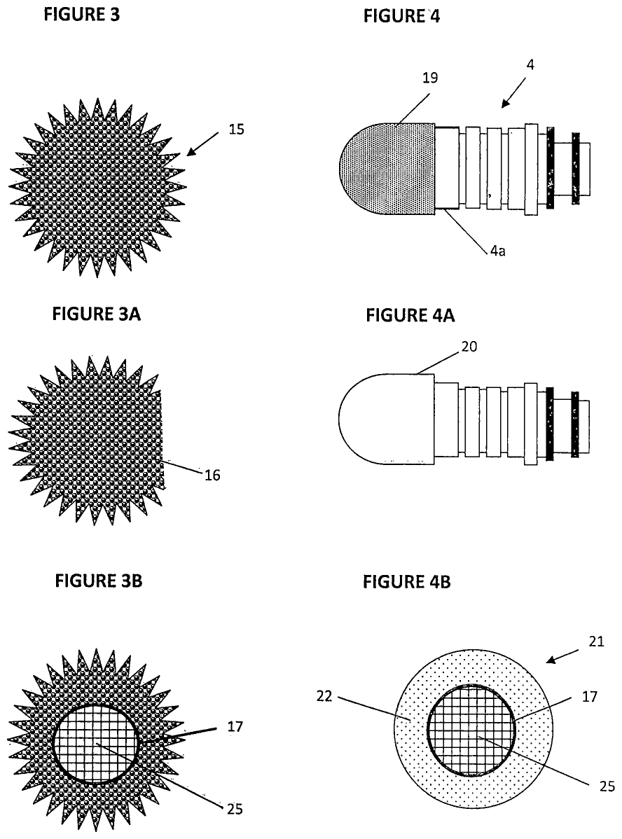

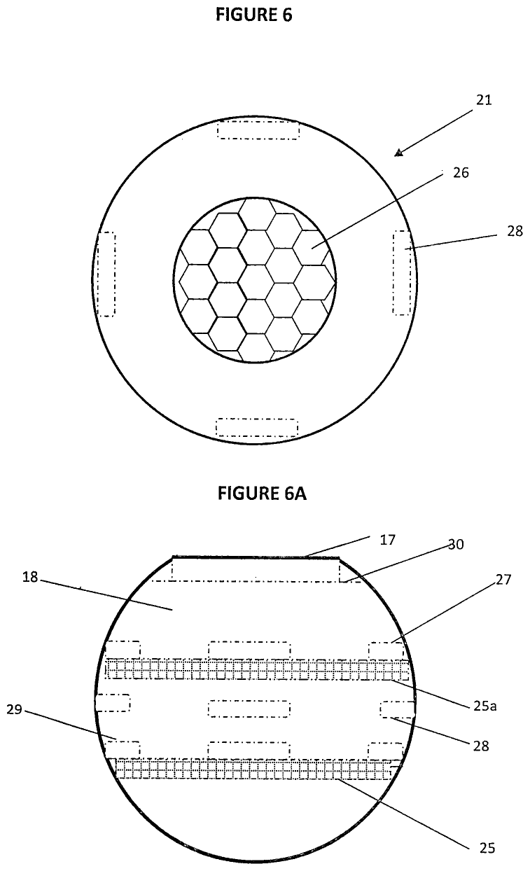

Another embodiment, depicted in FIGS. 3, 3A and 3B, is a ball 15 having a flexible brush, nubs or bristle surface covering a spherical segment of the ball. The ball has a flat bottom 16 (shown in FIG. 3A) with opening passage 17 (shown in FIG. 3B) open to an interior cavity 18 with details of the cavity presented in enlarged FIGS. 6 and 6A. FIG. 3B also shows a flexible net 25 located in the interior cavity. The ball 15 and flexible net are made of a flexible memory elastomer allowing the opening passage 17 to stretch upon entry of larger diameter massaging heads 19, 20 (shown as bullets in FIGS. 4, 4A. The opening passage 17 then rebounds to grip a narrower mid-portion 4a of the intermediate shaft 4 on which the massage heads 19, 20 are mounted.

FIG. 4B is a bottom view of an embodiment of a massage ball 21 with an interior cavity and opening passage 17. Massage ball 21 has a semi-smooth exterior surface 22 with an interior flexible net 25 the same as that of FIG. 3B. The interior cavity is sized to receive the massaging heads of FIGS. 4 and 4A.

The interior cavity 18 is depicted in greater detail in FIGS. 6 and 6A. Net 25 is shown near the bottom of the cavity 18. Optionally, another net 25a can be placed near the entrance to the opening passage 17 in addition to the net 25. Both nets 25 and 25a are formed of polyhedrons of adjacent hexagonal openings 26 also referred to as hexagonal prisms.

Attached to the interior surface of cavity 18 are a series of short parallel rows of small steps 27, 28, 29 used to alternatively pre-place the nets 25, 25a. The small steps are shown in phantom outline at spaced distances from a rim 30 of the opening passage 17. The row of steps 27 gives the spherical segment of the ball 15 a softer vibration feel when the net 25a is located closer to the rim 30. Either net maybe manufactured to a desired stiffness depending on the flexible memory elastomer material or combination of selected elastomers.

The hexagonal structure of nets 25, 25a allows transfer of warmth or coolness to the outer surface of the primary massage head In some therapeutic massage treatments. This can be done by inserting a preheated or frozen secondary massage head into the primary massage head to achieve a longer heating or cooling time.

FIGS. 2C and 2D depict another embodiment of the invention directed to the combination of a modified soft bellows massage head 39 which is detachably mounted over an intermediate mounting shaft 42 which in turn is mounted over a conventional drive shaft 56 of the JAWKU Muscle Blaster Mini percussive gun.

The soft bellows message head 39 has a double bellows 40, 41 similar to the previously discussed prior art massage heads 1 and 1a of FIGS. 1 and 2. One feature of this embodiment is that a disc 44 is attached on top of the intermediate mounting shaft. The disc has a curved surface serving as a small massage head relative to the larger massage head 39 when the two are separated. The disc 44 has an overhang 44a extending over a cylindrical skirt 45 of the intermediate mounting shaft 42. The cylindrical skirt 45 is a band with an inner wall 45a (shown in phantom) open at the bottom thereof.

The diameter of the disc 44 is larger than a diameter of an annular flexible opening 43 shown at the bottom of bellows 41. The disc 44 is slipped over an inner rim 43a of opening 43 into a cavity 41a of the bellows 41. The inner rim 43a then grips the skirt 45. The disc 44 serves the duo purposes of being a connecter for the intermediate mounting shaft and the massage head 39 and when detached a smaller secondary disc massage head. A center air passage 46 extends through the disc 44 into the skirt.

FIG. 2C is an exploded view of the disassembled massage head 39, intermediate mounting shaft 42 and forward portion of the drive shaft 56. Massage head 39 is also called a soft bellows massage head and may have more than one bellows. The term “bellows” as used in this disclosure means a single chambered or multi-chambered bellows. The top surface 39a of massage head 39 may have an optional beaded surface, a smooth surface or a serrated surface. Annular opening 43 is stretchable and made of a flexible memory elastomer. Although not shown, flexible hexagonal nets similar to the previously described nets 25, 25a may optionally be located to span across the cavity juncture of the bellows 40, 41 to regulate the rate of air flow.

The inner end wall 45a surrounds a recessed surface 45c. Alignment posts 47, 48, 50 and 51 (shown in FIG. 2D) project downward from the recessed surface. The inner end wall 45a terminates in an inwardly projecting flexible lip 45b to slip over drive shaft 56. As shown in FIG. 2C, a groove 56a is placed around the circumference of the drive shaft 56. Four recesses, two of which are shown in phantom as recesses 47a, 48b, receive alignment posts 47, 48 with the two alignment posts 50, 51 also aligned with recesses (not shown) in the FIG. 2C view. The posts are centering guides for intermediate mounting shaft 42.

The user stretches an end of skirt 45 to allow the projecting lip 45b to firmly grip the groove 56a thereby seating the intermediate mounting shaft 42 over the drive shaft.

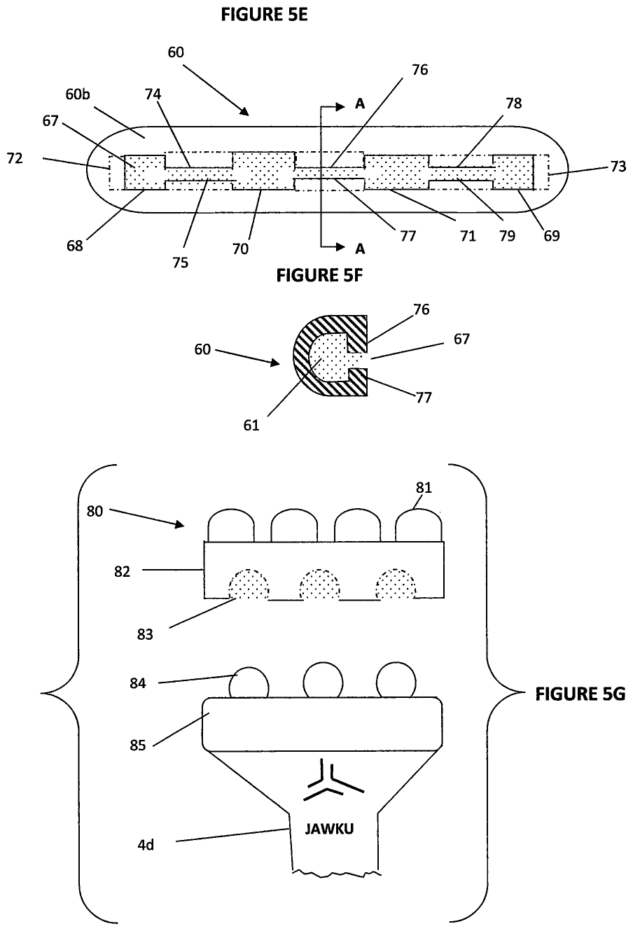

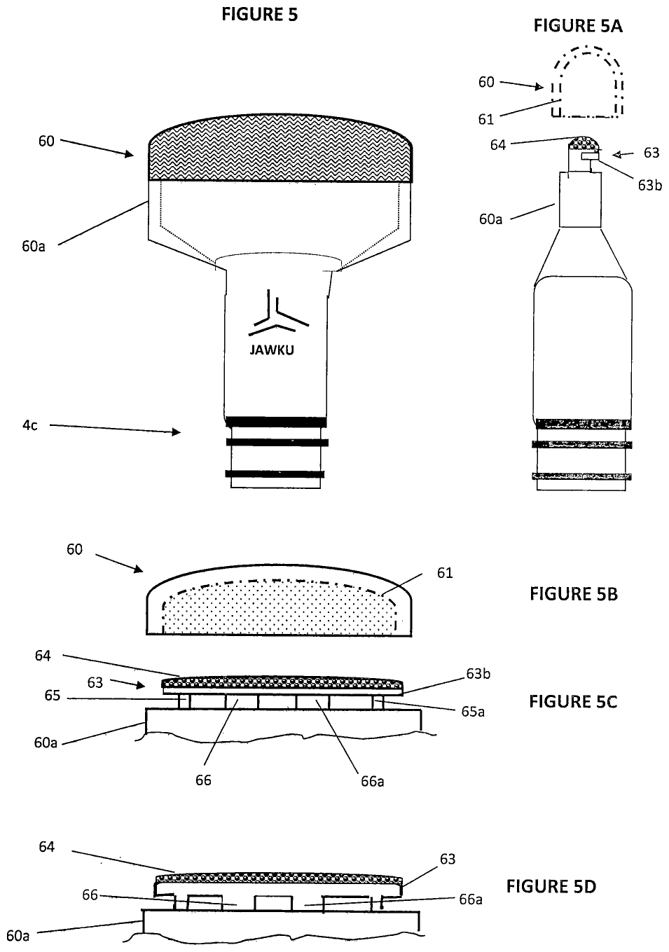

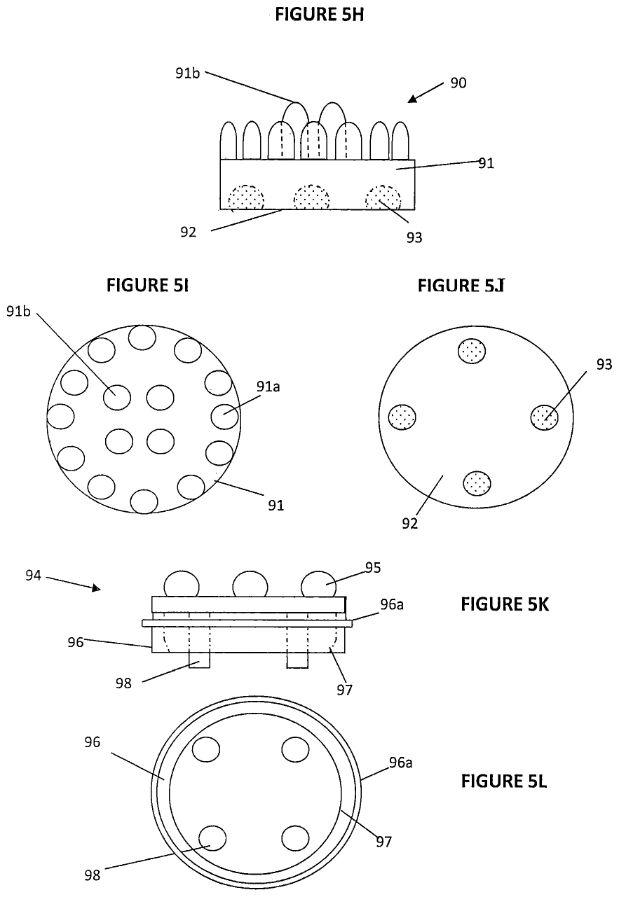

FIGS. 5, 5A-5F illustrates an embodiment of a scraper massage head 60. In FIG. 5, an undulating pattern of multiple scraper rows cover both external surface sides of the scraper massage head 60. This pattern provides a pulsating massage rub per pass along a wide skin surface area with the undulating pattern acting as a multi-wave massaging surface. The scraper massage head 60 is a flexible cap with a bottom opening cavity 61 snugly fitting over a smaller scraper massage head 63 nested in the hollow cavity 61 (shown in FIGS. 5A, 5B) of the scraper massage head 60. The smaller scraper massage head 63 (shown in FIG. 5A, FIG. 5C and FIG. 5D) has a top surface pattern such as marbled beads 64 and is attached to an upper portion 60a of an intermediate mounting shaft 4c. Outer support pillars 65, 65a support the ends of the massage head 63 along with a pair of spaced apart inner pillars 66, 66a. Between the two inner pillars 66, 66a is a middle open space. Between outer pillar 65 and inner pillar 66 is an open space. Between outer pillar and inner pillar 66a is another open space.

FIG. 5A represents a side view of the massage head scraper 60 shown with the smaller massage head 63 removed. The outer and inner support pillars are beneath and support an underside 63b of the massage head 63 as best shown in FIG. 5C. FIGS. 5C and 5D are front and back views of the smaller massage head 63 showing a difference in the support pillars front and back sides with an overhang 63b (best seen in FIG. 5A) of the front side view. The flexible massage head scraper 60 when slipped over the smaller massage head 63 is engaged by the overhang 63b.

FIG. 5E is a bottom view of the massage head scraper 60 showing a slotted passage opening 67 having end rectangular openings 68 and 69 for insertion of and containment of support pillars 65, 65a. Larger rectangular openings 70, 71 are in the middle of slotted passage opening 67 for insertion of and containment of inner pillars 66, 66a. The outer ends 72, 73 of openings 68, 69 are covered as shown by dotted lines as hidden from view recesses sized to engage the ends of overhang 63b.

Three sets of split apart rectangular retainer tabs 74, 75 and 76, 77 and 78, 79 are part of the slotted passage opening 67. These three sets of retainer tabs interconnect with the end and middle rectangular openings.

The three sets of retainer tabs are sized to align with and fit into the middle and the end open spaces previously described between the inner and outer pillars. The massage head scraper 60 consists of a rubbery elastomeric material which is stretchable to permit the smaller massage head 63 of a firmer material to be inserted into the hollow cavity 61. The flexibility of the massage head scraper 60 allows the slotted passage opening 67 to stretch widthwise causing the split sets of retainer tabs to be pulled further apart enough to engage and partially surround and grip sides of the pillars of the smaller massage head 63.

FIG. 5F is a side sectional view AA of the massage head scraper 60 of FIG. 5E taken at the midpoint of the slotted passage opening 67. The outer ends 72 and 73 are shown in outline form as extensions of apertures 68, 69. These extensions are stretchable to accept the very ends of smaller massage head 63 which ends are not flexible.

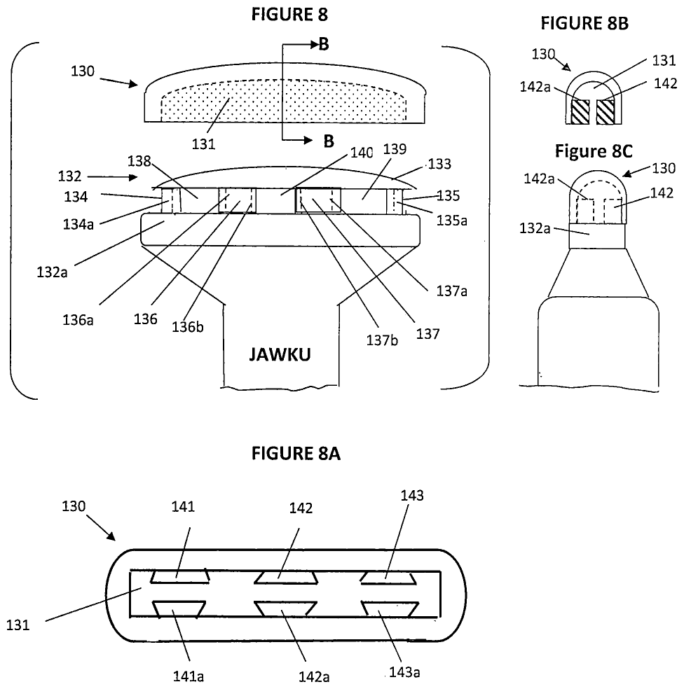

A different embodiment of the scraper embodiment disclosed above in FIGS. 5, 5A-5F is depicted in FIGS. 8, 8A, 8B, 8C. Referring to FIG. 8, an exploded front view is depicted of a flexible hollow massage scraper head 130 with downwardly open cavity 131 shown separated from a smaller scraper massage head 132 having a curved massage surface 133. The smaller scraper massage head 132 is mounted on one end of an intermediate mounting shaft 132a. The massage head doubles as a mount fitted inside the hollow massage scraper head 130. Outer support pillars 134, 135 support the ends of the massage head 132 along with inner support pillars 136, 137.

FIG. 8a is a bottom view of the scraper cavity 131 showing three sets of spaced split tabs (141, 141a), (142, 142a), (143, 143a) sides faced inwardly along the cavity 131. Openings 138, 139 and 140 are sized to allow flexible split tabs to be squeezed into the openings from each pillar side. The base of each tab set is trapezoidal in shape. Each tab set has flexible trapezoidal corners permitting entry and removal of the massage scraper head 130. The trapezoidal corners fit complementary sets of recesses (134a, 136a), (136b, 137b) and (137a, 135a) in pillars 134, 136 and 137 as illustrated in FIG. 8. The split tabs grip the sets of complementary recesses in the inner and outer support pillars of the massage head 132.

FIG. 88 is a partial sectional view B-B taken along the midpoint of scraper head 130 as shown in FIG. 8. FIG. 8B shows the downwardly open cavity 131.

FIG. 8C is a side view of the scraper head 130 mounted over the smaller scraper head 132 showing in phantom the set of slit tabs 142, 142a.

Another embodiment of the invention is shown in FIG. 5G which is an exploded front view of a massage head 80 have a row of flexible massaging fingers or paddles 81 attached to a mounting support 82. The massaging fingers 81 have a “blunted” tip head 81a which is curved or domelike to provide a wider but less penetrating massage over thin skin on top of bone and cartilage.

A row of semi-spherical cavities 83 are recessed in the mounting support 82 with at least open ends of the cavities being flexible to permit entry and removal of semi-spherical balls 84 sized to snugly fit inside the cavities. The semi-spherical balls are attached to the top portion 85 of an intermediate mounting shaft 4d. The semi-spherical balls 84 serve as a secondary massage head when the massage head 80 is removed.

A further embodiment is a massage head 90 shown in FIGS. 5H, 5I and 5J. Massage head 90 is adapted to be mounted to an intermediate mounting shaft 94 (shown in FIGS. 5K-5L) which slips over a drive shaft, such as the drive shaft 56 (shown in FIG. 2C) of the JAWKU Muscle Blaster Mini. FIG. 5H is a front view of multiple flexible domes with a center cluster of cylinders 91b being taller than perimeter cylinders 91a projecting from a disc 91 (best shown in FIG. 5I) in a clock like 12 hour pattern. The taller center cluster of cylinders 91b are arranged in a square pattern. Semi-spherical cavities 93 are recessed in the bottom 92 of disc 91 and may be at least four to six in number equally spaced as shown in the bottom view FIG. 5J. Only three recesses 93 are depicted in FIG. 5H with a fourth being shown in FIG. 5J.

A variation (not shown) of the massage head 90 embodiment of FIG. 5H may have the center cluster of cylinders 91b lower in height then the perimeter cylinders 91b. This variation is particularly useful in massaging of small knee caps and elbows as well as an extended elbow or knee. A simple short screw in the bottom of the cylinders with complementary aligned screw holes in the top of an intermediate mounting shaft would provide yet another massage head assembly choice.

FIG. 5K is a side view of an intermediate mounting shaft 94 and shows three semi-spherical balls 95 with a fourth being hidden directly behind the center semi-spherical ball. The semi-spherical balls are sized to fit the cavities 93 and have a duo fastening function and massage head function. Shaft 94 has a flexible skirt 96 with an inward projecting lip 97 and aligning posts 98 the same as those depicted in FIG. 2C. Skirt 96 has an external small ring 96a attached providing the user a finger hold. FIG. 5L is a bottom view of the shaft 94 showing the circular periphery of lip 97 and the alignment posts 98 (which can be optional) used as guides for seating the intermediate shaft on the drive shaft 56.

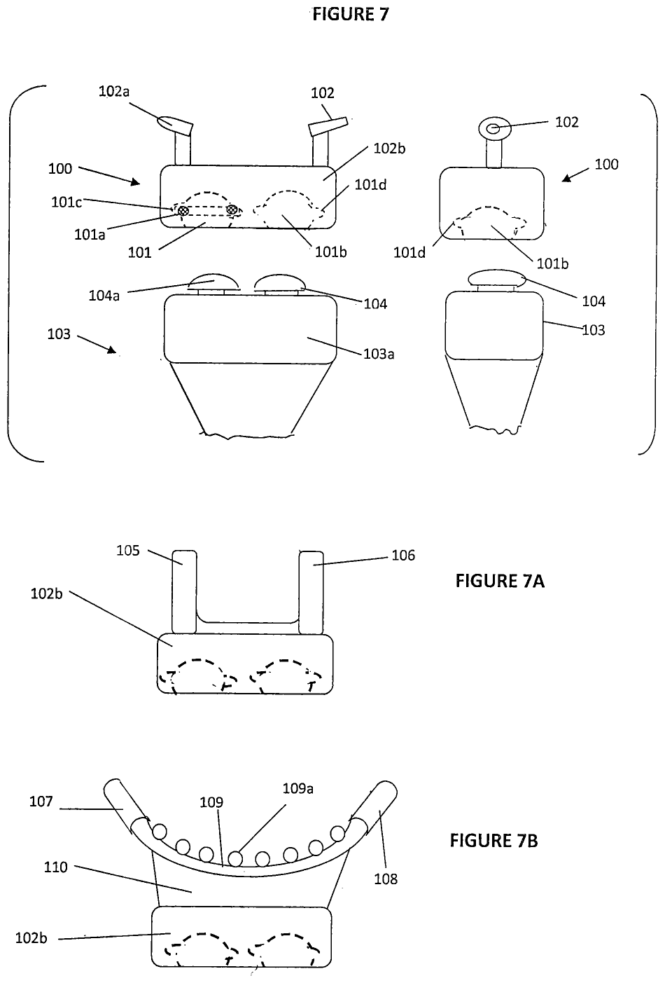

FIG. 7 depicts exploded front and side views of an embodiment of a two pronged spaced fork massage head 100 mounted in combination with an intermediate mounting shaft 103. The massage head 100 is a claw toe massage head consisting of dual outwardly and upwardly projecting claw heads 102 and 102a. Although referred to as a claw toe message head, the head 100 is equally capable of massaging other body extremities. Examples of different massaging surfaces are shown for the claw heads 102 and 102a with claw head 102 shaped in the form of a truncated cone bullet and claw head 102a shaped as a cone bullet. Both claw heads may be identical. The claw heads 102 and 102a are mounted above a mounting portion 102b having internal semi-spherical cavities 101, 101b (shown in phantom) for receiving semi-spherical massage heads 104, 1o4a. The massage heads 104, 104a are attached to a forward portion 103a of the intermediate mounting shaft 103. Massage heads 104, 104a are sized to snap fit within the semi-spherical cavities 101, 101b. It is to be understood that the term “snap fit” refers to the use of small tightly wound snap rings 101a seated inside of elliptical grooves 101c, 101d intersecting the periphery of the semi-spherical cavities 101, and 101b. Only snap ring spring 101a is shown in place in the top left portion of FIG. 7. The small snap rings contract or expand around semi-spherical massage heads 104, 104a being inserted by the user into the semi-spherical cavities 101, 101b. The term “snap fit cavity or cavities” refers to the combo-elliptical semi-spherical shape of the cavity.

The mounting portion 102b consists of a flexible memory elastomer allowing the expansion of a bottom facing opening of the semi-spherical cavities to permit entrance of the semi-spherical heads sized to fit in the semi-spherical cavities.

FIGS. 7A and 7B are variations of forked massage heads sized for mounting on the same 102b mounting portion including the semi-spherical cavities as the embodiment of FIG. 7. The intermediate mounting shaft 103 of FIG. 7 is used to mount the FIG. 7A and FIG. 7B embodiments. The massage surface of FIG. 7A embodiment is a straight up U fork set 105, 106.

FIG. 7B has a wide Y support cradle 109 having a curvature with end handles 107, 108. The wide Y support cradle enables the simultaneous massaging of spaced apart lower portions of body limbs such as between legs by the end handles. A curved cradle portion 110 forms the center of the Y attaching the cradle 109 to the mounting portion 102b. Massaging beads 109a are attached to the curvature.

The massage heads of FIGS. 7, 7A and 7B all use the same intermediate mounting shaft 103 wherein the semi-spherical heads 104, 104a function as a connector and a secondary stand alone massage head.

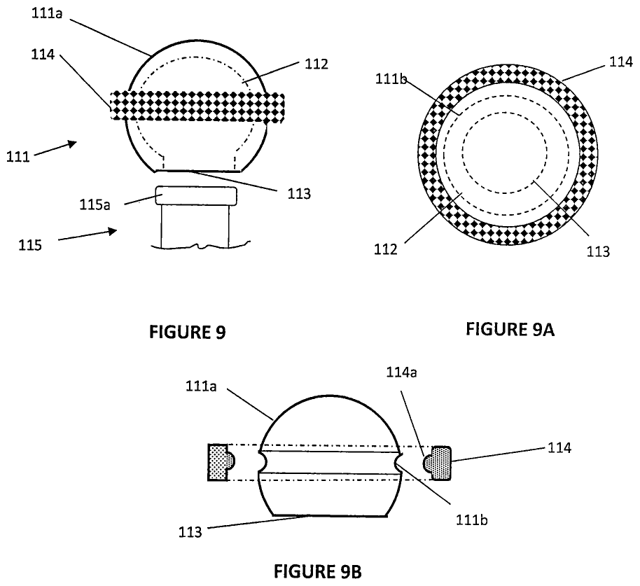

FIG. 9 is a side view of another massage head embodiment having a hollow ball massage head 111 separated from an intermediate mounting shaft 115. Massage ball head 111 has an interior hollow cavity 112 with an open bottom rim 113. Massage ball head 111 is a flexible semi-spherical surface 111a with the bottom rim 113 open for entry and removal of a flat disc 115a mounted at one end of shaft 115. The disc 115a is porous with air vents (not shown) allowing air to escape and re-inflate the hollow cavity 112 during the percussive massage cycles. The number and size openings of the vents aids in controlling the volume of air movement within the cavity 112 depending on the softness of the massage semi-spherical surface 111a.

A stretchable removable ring band 114 with an outer raised diamond surface pattern is attached circumnavigating the surface 111a. Alternately, other surface raised patterns or a segmented mix of patterns may be selected including a smooth surface pattern. FIG. 9A is a top view of the ring band joined on the circumference of the massage ball head 111.

The ring band 114 consists of flexible rubbery memory material shown in FIG. 9B in a removed stretched configuration to show an endless groove 111b in the massage head surface 111a. A semi-spherical annular bead 114a projects from the inner surface of the outer ring band 114. The semi-spherical annular bead is sized to snugly fit within the groove 111b. The raised diamond surfaced pattern of the outer ring band 114 provides a scraping movement during pulsing reciprocation strokes by the massage gun.

Alternatively (not shown), the semi-spherical annular bead 114a may project from surface 111a with the endless groove in the inner surface of the ring band 114. This is preferred in instances where massaging is done over thin clothing by the massage ball head 111 with the ring band detached to avoid catching on thin clothing.

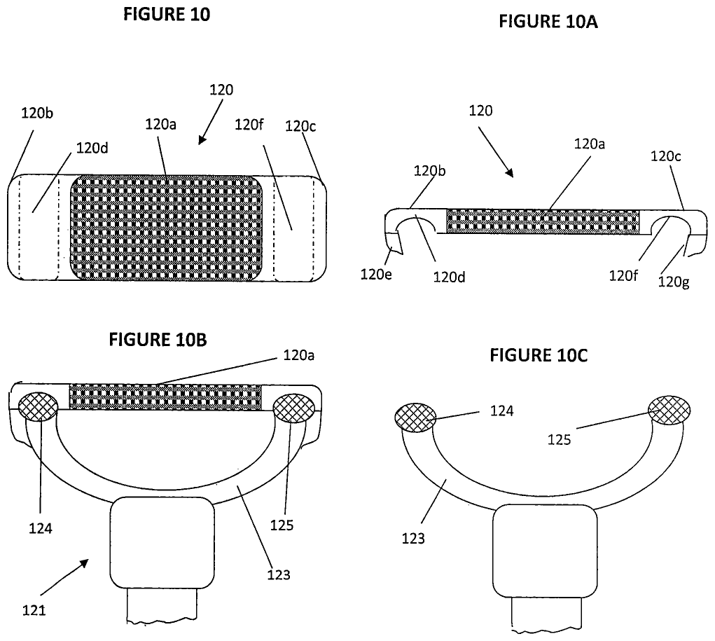

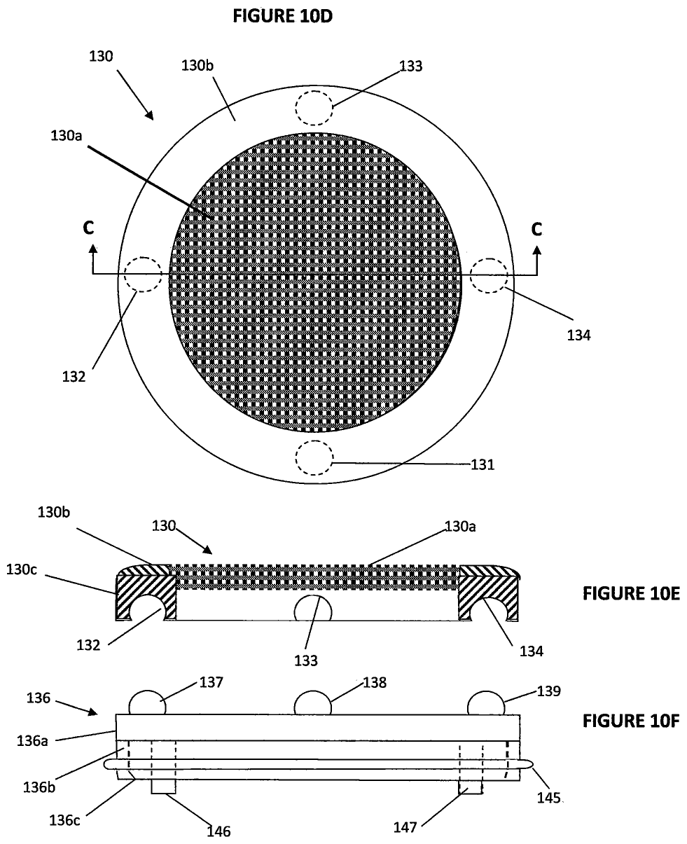

FIGS. 10, 10A, 10B and 10C disclose an embodiment of a primary massage head 120 for removable attachment with an intermediate mounting shaft 121. FIG. 10 is an overhead view of the massage head 120 having a recoil net 120a. FIG. 10A is a side view of the recoil net 120a with several layers of memory elastomeric material of flexible hexagonal interconnected cells having hexagon openings.

Recoil net 120a is fastened between end sections 120b, 120c. End section 120b has a groove 120d facing open downwardly and is attached to a curved finger extension 120e which is flexible and extends below the groove. End section 120c has a groove 120f facing open downwardly with a curved finger extension 120g which is flexible and extends below the groove 120f.

In FIG. 10B, the curved finger extensions 120e, 120g face each other and stretch apart the recoil net 120a of the primary massage head 120 mounted over ends 124, 125 of a secondary Y shaped message head 123. The secondary massage head 123 (shown separately in FIG. 10C from attachment to the recoil net) has parallel massage bars 124, 125 with elliptical cross-sections sized to fit within the grooves 120d, 120f when the user spreads the curved finger extensions 120e and 120g apart. The secondary Y shaped massage head 123 has a central portion affixed to a top end of the intermediate mounting shaft 121. The parallel massage bars 124, 125 are used as a secondary massage head when the recoil net is detached from the parallel bars.

FIG. 10D is a top view of an another embodiment 130 of a massage head 130 consisting of a circular recoil net 130a fastened to abut within an open collar frame 130b and underlying collar 130c. The recoil net 130a is formed of at least one layer of memory elastomeric material having multiple adjacent hexagonal hexagon openings. The underlying collar 130c which is flexible has a bottom with four semi-circular downward opening spherical cavities 131, 132, 133, and 134. FIG. 10E is a cross sectional view taken from the cross-section CC of FIG. 10D depicting three of the cavities.

FIG. 10F is a side view of an intermediate mounting shaft 136 having a flat disc 136a to which are affixed at least four semi-spheres of which three, 137, 138 and 139 are shown. The four semi-spheres serve the duo purpose of being a snap fastener for the embodiment of the circular recoil net 130 and as a secondary massage head when not attaching the circular recoil net. The semi-spheres are aligned and sized to engage and snap into the spherical cavities 131-134 of the circular recoil net 130.

The intermediate mounting shaft 136 is slipped over the drive shaft 56 into the groove 56a of the JAWKU Muscle Blaster Mini shown previously at the bottom of FIG. 2C. Attached to the underside of the flat disc 136a is a flexible band 136b with an inner end lip 136c for retaining the intermediate mounting shaft when slipped over the drive shaft 56 into the groove 56a. A protruding thin circular rib extends from an outer wall of flexible band 136b to which it is attached and provides a protuberance for the fingers of a user to grip and slip the massage head 130 over the massage gun shaft. Also optionally attached to the underside of the disc 136a by screws are four alignment posts, two of which alignment posts 146, 147 are shown in the FIG. 10F side view. The alignment posts are aligned and sized to fit into the receiving recesses, such as 47a, 48a shown in FIG. 2C.

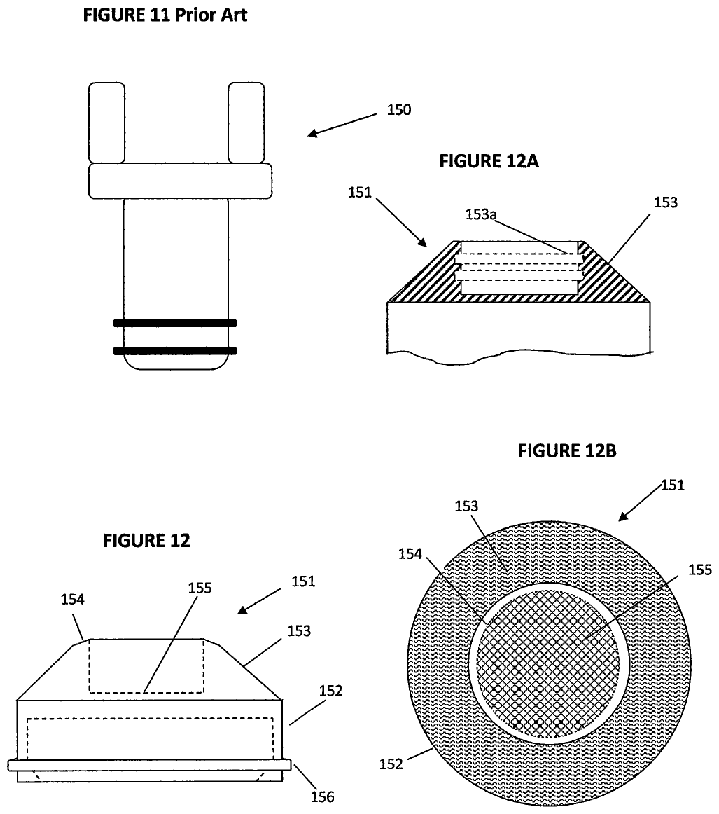

Another embodiment is disclosed of an intermediate mounting shaft adapter 151 shown in the FIG. 12 side view with a more detailed partial upper sectional view shown in FIG. 12A with FIG. 12B being a top view. These views depict an intermediate mounting shaft adapter 151 having a lower circular skirt 152 for slipping over a head of a drive shaft (shown earlier in FIG. 2C) of a JAWKU MUSCLE BLASTER MINI percussive massage gun. A finger rib 156 surrounds the skirt to aid mounting and removal. A secondary massage head 153 is attached atop the skirt 152 in the shape of a truncated conical cone 153 having a raised pattern of undulating waves. The top of this cone has an opening 155 sized to match a shaft receiving opening in drive shafts of larger massage guns such as the drive shafts used by the JAWKU MUSCLE BLASTER V2 or the JAWKU MUSCLE BLASTER CHROME. A bevel surface 154 surrounds the top of opening 155 serving as a secondary massage hammer and also to avoid a possible sharp edge of the opening catching thin clothing of a user when just the surfaces of cone 153 or bevel 154 are to be used alone as a secondary massage head. The novel intermediate shaft adapter 151 enables a user the choice of mounting an assembly of known bigger massage primary massage heads on shafts used in bigger massage guns having the two O-rubber rings shown in black outline in the FIG. 11 fork massage head 150.

### SUMMARY

It is intended by the inventor that the above disclosure's use of terms in the singular also include the plural, such as by way of non-limiting example “cavity” and “cavities”. It is to be also understood that the meaning of cavity is to be given a broad definition such as void, groove, recess or hollow and are to be interpreted as interchangeable.

It is intended that the term “primary massage head” is used to broadly cover the various embodiments of a message head having a cavity accessed by a flexible opening through which a secondary massage head is sized to enter.

Alternatively, this term also covers those massage head embodiments ending in a shaft capable of fitting in either a drive shaft of a large percussive massage gun or in the disclosed adapter shaft capable of being slipped over the drive shaft of a compact percussive massage gun. The terms percussive or percussion are considered interchangeable.

It is apparent that one skilled in the art may envision obvious variations on the above embodiments and it is intended by the inventor that all such embodiments be accorded the full legal protections enshrined in the U. S. Constitution's mandate of Article 1, Section 8 and as set forth in the Federal Patent Laws and Court decisions and as such be broadly interpreted as only examples of the claimed subject matter for which the inventor has a lawful right to secure.

What is claimed is:

1. An assembly of a multitude of interchangeable massage heads for use with percussive massage guns having different drive shafts, each assembly comprising at least one primary massage head and at least one secondary massage head; the at least one primary massage head having at least one or more cavities with a flexible opening; the assembly further comprising
at least one intermediate mounting shaft having a proximal end and a distal end with the proximal end having the at least one secondary massage head wider than a width of the flexible opening but less than a width of the cavity; and
the at least one secondary massage head being sized to fit within the at least one cavity in a snug gripping engagement with the flexible opening.

2. The assembly of claim 1 further comprising wherein the distal end of the intermediate mounting shaft is sized to fit inside of or over at least one drive shaft of at least one of the percussive massage guns.

3. The assembly of claim 1 further comprising the at least one secondary massage head is at least one of a spherical sector, a conical bullet, a saucer shaped disc, a scraper blade, a hammer or a duo bar scraper.

4. The assembly of claim 1 further comprising at least one secondary massage head has at least one air channel with access to the at least one cavity.

5. The assembly of claim 1 further comprising the at least one primary massage head and/or the at least one secondary massage head consists of a memory material with hypoallergenic properties.

6. The assembly of claim 1 further comprising the at least one primary massage head is a flexible net supported by either a circular frame or a rectangular frame; and both the circular frame and the rectangular frame further having plural cavities with a flexible opening.

7. The assembly of claim 6 further comprising the flexible net consisting of a recoil net comprising multiple hexagonal open ended hexagons.

8. An assembly of multiple massage heads interchangeable over or in drive shafts of percussive massage guns, each massage head comprising at least one of a primary massage head shaped as at least one of a two-fork massage head, a rake paddle massage head, a scraper massage head, a hollow ball massage head, a bellows massage head, a cone massage head, a bullet massage head, a hammer massage head or a recoil net massage head;
the at least one primary massage head further having a bottom portion with plural spaced apart cavities shaped as at least one of elliptical cavities, spherical cavities or combo-elliptical-spherical cavities with the spaced apart cavities each having a flexible opening; and
the assembly further comprising an intermediate mounting shaft having at least one secondary massage head on a forward portion and
the forward portion partially mounting at least one of spaced apart ellipsoids or spheres or combinations thereof and at least one of the spaced apart ellipsoids or spheres having an elliptical or spherical segment sized to snugly fit at least one of the plural spaced apart cavities; and
at least one of the ellipsoids or spheres projecting above the forward portion of the intermediate mounting shaft and aligned for passage through the flexible opening; and the intermediate mounting shaft having a rear portion being sized to snugly fit in or over the drive shafts of the percussive massage guns.

9. The assembly of claim 8 wherein at least one of the primary massage heads is one of a soft bellows head, a flexible hollow ball head, a multi-level bullet head or a flexible recoil net head.

10. The assembly of claim 9 wherein the flexible recoil net head consists of at least one elastomeric layer with the at least one elastomeric layer having multiple interconnecting hexagonal open ended hexagons.

11. The assembly of claim 10 wherein the flexible recoil net head is held by a circular or rectangular framework having an underside consisting of at least one of a multiple of semi-spherical cavities;
and at least one shaft of the intermediate mounting shafts has a proximal end supporting semi-spheres sized and aligned to fit within the semi-spherical cavities.

12. An assembly of interchangeable massage heads for percussive massage guns, the assembly comprising at least one primary massage head consisting of at least one of a flexible hollow ball massage head, a multi-cone massage head, a multi-bullet massage head or a flexible recoil net massage head;
the at least one primary massage head further having a bottom portion with spaced apart cavities shaped as at least one of elliptical cavities, spherical cavities or combo-elliptical-spherical cavities with the spaced apart plural cavities each having a flexible opening;
the at least one primary massage head additionally comprising an intermediate mounting shaft having a forward portion and a rear portion,
the forward portion having mounted thereon spaced apart partial ellipsoids or spheres or combinations thereof, with the ellipsoids or spheres each having an elliptical or spherical segment sized to snugly fit the spaced apart cavities;
the elliptical or spherical segments projecting above the forward portion of the intermediate mounting shaft and aligned for passage through the flexible opening.

13. A combination for selective mounting over or in different shaped drive shafts of percussive massage guns, the combination comprising a first group of primary massage gun heads and a second group of secondary massage gun heads wherein at least one of the primary massage gun heads has at least one flexible cavity with a flexible rim opening in which at least one of the secondary massage gun heads partially fits, and the combination further comprising at least one intermediate mounting shaft wherein the at least one intermediate mounting shaft has a proximal end and a distal end; the proximal end mounting at least one of the secondary massage heads and the distal end sized to be snugly mounted over or in one of the different shaped drive shafts of one of the percussive massage guns.

14. An adapter converter shaft for mounting a massage gun head which is attached to an intermediate mounting shaft having a distal end sized to fit in a snug manner within either an opening of a first drive shaft of a percussive massage gun or unto a top of a second drive shaft of a short stroke percussive massage gun, the adapter converter shaft formed as a secondary massage head having a truncated conical cone with a center top hole sized to permit an insertion of the distal end of the intermediate mounting shaft in a snug manner within the center top hole.

15. The adapter converter shaft of claim 14 further comprising a bottom of the truncated conical cone has a flexible skirt sized to fit snugly unto the top of the second drive shaft.

16. The adapter converter shaft of claim 15 wherein the flexible skirt is cylindrical in shape and made of a memory material.

17. The adapter converter shaft of claim 14 wherein a first portion of the truncated conical cone has a surface comprising an undulating raised parallel or unparallel wave pattern for use as a secondary massage head scraper.

18. The adapter converter shaft of claim 17 wherein a second portion of the truncated conical cone is adjacent the center top hole and has a flat surface for use as a secondary massage head hammer.

19. The adapter converter shaft of claim 14 wherein the truncated conical cone has a cone portion covered by plural undulating raised patterns of waves for use as a massaging scraper.

20. The adapter converter shaft of claim 18 wherein the flat surface is a continuous bevel joining the center top hole.
